(19) United States
(12) Patent Application Publication
(10) Pub. No.: US 2023/0008909 A1
(43) Pub. Date: Jan. 12, 2023

(54) AUTOMATED CALIBRATION SYSTEM AND METHOD FOR THE RELATION BETWEEN A PROFILE-SCANNER COORDINATE FRAME AND A ROBOT-ARM COORDINATE FRAME

(71) Applicant: Industrial Technology Research Institute, Hsinchu (TW)

(72) Inventors: CHENG-KAI HUANG, Taichung City (TW); ZHI-XIANG CHEN, Taichung City (TW); JAN-HAO CHEN, Changhua County (TW)

(21) Appl. No.: 17/573,922

(22) Filed: Jan. 12, 2022

(30) Foreign Application Priority Data
Jul. 6, 2021 (TW) 110124736

(51) Int. Cl. B25J 9/16

(52) U.S. Cl. CPC B25J 9/1692

(57) ABSTRACT

An automated calibration system for the relation between a robot-arm coordinate frame and a profile-scanner coordinate frame includes a ball probe, a distance sensor module, a profile scanner and a control module. The ball probe is attached on a flange of a robot arm. The distance sensor module includes at least three distance sensors having respective axes sharing a common sensing plane and intersecting at a common point. The profile scanner is used for detecting a 2D cross-sectional profile of the ball probe. The control module is electrically connected with the distance sensor module, the profile scanner and the robot arm so as to control the robot arm to move the ball probe to obtain calibration information. In addition, an automated calibration method for the relation between the profile-scanner coordinate frame and the robot-arm coordinate frame is also provided.

### CROSS REFERENCE TO RELATED APPLICATION

This application claims the benefits of Taiwan application Serial No. 110124736, filed on Jul. 6, 2021, the disclosures of which are incorporated by references herein in its entirety.

### TECHNICAL FIELD

The present disclosure relates in general to a calibration method of a robot arm, and more particularly to an automated calibration method for a relation between a robot-arm coordinate frame of a robot arm and a profile-scanner coordinate frame of a profile scanner. In addition, this present disclosure relates also to an automated calibration system for the relation between the robot-arm coordinate frame and the profile-scanner coordinate frame.

### BACKGROUND

In automated manufacturing, robot arms have been widely applied to greatly enhance efficiency and quality in productions. While in using the robot arms to carry out automation, associated tooling is generally installed directly to the robot arm, and a manual teaching method is usually introduced to formulate a trajectory plan for the robot arm to follow automatically in later productions. However, with diversification in robotic applications and progress in autonomous decision-making technology, more and more response judgments have been made in an online manner according to real-time information captured by sensors. Nevertheless, accuracy of these online responses is significantly affected by position relationships among sensors, workpieces, and robot arms. Therefore, accurate positioning, especially in locating relative coordinate relationship, has become one of important indicators to determine whether or not the robot arm can achieve precise operations.

In applying the robot arm to perform automation with autonomous decision-making, the positioning relationship among sensors, workpieces, tooling and robot arms shall be accurate firstly. However, due to inevitable mounting and manufacturing tolerances, positioning error would occur always. Thus, before the robot arm can be applied to perform any action, relative positioning in each coordinate frame shall be corrected through a calibration process in advance.

In the art, a typical calibration method identifies physical feature points through naked eyes or sensors, then controls the robot arm to coincide a tool center point (TCP) with each of several designated points in a predetermined coordinate frame, and finally records the corresponding coordinates to complete the positioning calibration with respect to the coordinate frame.

However, when the robot arm is paired with sensors to perform action decisions, these sensors shall be fixed definitely before any detection can be started. However, to sensors with different sizes or appearances, human labors are always needed to re-calibrate positions of these sensors so as to contain associated mounting tolerances. It can be assured that this re-calibration process would cause time and labors.

In the case that a coordinate frame does not have any physical feature point while in calibrating the coordinate frame of sensor, although there already exist automatic calibration methods, yet these existing methods generally utilize a fixture as media to pair a CAD model for processing the calibration upon the coordinate frame. As such, dimensions of the fixture would affect the calibration results. In addition, these methods usually mount sensors and the fixture onto the robot arm so as able to obtain sufficient information by having the robot arm to generate relative motion between the fixture and each of the sensors. However, due to inevitable movement bias at the robot arm, the method for obtaining the closest solution through numerical approximation might meet divergence, and thus a correction result may never arrive to provide improvement upon the calibration.

Accordingly, it is the object of this disclosure to develop an automated calibration method and system for a relation between a robot-arm coordinate frame and a profile-scanner coordinate frame. In this method and system, no physical feature point is needed in the coordinate frame, no fixture is required to perform as a calibration medium, no CAD model should be applied as an assistance, and no device's coordinate should be calibrated in advanced. With this method and system, calibration of the coordinate frames can be completed in one operation procedure, and the aforesaid shortcomings in the prior art that the coordinate frame shall have physical feature points and a fixture shall be applied to improve the accuracy of calibration can be substantially resolved.

### SUMMARY

In one embodiment of this disclosure, an automated calibration method for a relation between a robot-arm coordinate frame and a profile-scanner coordinate frame includes the steps of:

(a) disposing a ball probe having a predetermined radius on a flange of a robot arm, and arranging a distance sensor module and a profile scanner, the distance sensor module including at least three distance sensors, three axes corresponding to the three distance sensors sharing a common sensing plane and intersecting at a point of intersection; wherein the ball probe, the robot arm, the flange, the distance sensor module and the profile scanner have a ball-probe coordinate frame, a robot-arm coordinate frame, a flange coordinate frame, a distance-sensor-module coordinate frame and a profile-scanner coordinate frame, respectively;

(b) controlling the robot arm to move the ball probe to undergo a triaxial movement along the robot-arm coordinate frame, and thus to establish a transformation relationship between the robot-arm coordinate frame and the distance-sensor-module coordinate frame;

(c) utilizing distance information detected by the distance sensor module to control the robot arm at one of different postures to move a spherical center of the ball probe to the point of intersection, so as to coincide an origin of the distance-sensor-module coordinate frame with the spherical center of the ball probe, and further to record all axial joint angles of the robot arm into calibration point information of a tool center point (TCP);

(d) calculating a coordinate of the spherical center of the ball probe with respect to the flange coordinate frame as an instant coordinate of the TCP;

(e) controlling repeatedly the robot arm to experience all the different postures so as to allow the profile scanner to capture respective information of the ball probe and the profile scanner to obtain respective cross-sectional profile information of the ball probe, and to apply a circle fitting method and the Pythagorean theorem to derive respective center coordinates into the calibration point information with respect to the profile-scanner coordinate frame; and

(f) deriving the relation between the profile-scanner coordinate frame and the robot-arm coordinate frame, and inputting all the calculated coordinates into a control module for completing calibration.

In one embodiment of this disclosure, an automated calibration system for a relation between a robot-arm coordinate frame and a profile-scanner coordinate frame includes:

a ball probe, attached on a flange of a robot arm;

a distance sensor module, including at least three distance sensors, three axes corresponding to the three distance sensors being coplanar with a sensing plane of the at least three distance sensors, the three axes being intersected at a point of intersection;

a profile scanner, used for detecting a 2D cross-sectional profile of the ball probe; and

a control module, electrically connected with the distance sensor module, the profile scanner and the robot arm, configured for controlling the robot arm to move the ball probe for obtaining calibration point information.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic front view of an embodiment of the automated calibration system for a relation between a robot-arm coordinate frame and a profile-scanner coordinate frame in accordance with this disclosure;

FIG. 2 is a schematic top view of the distance sensor module and the profile scanner of FIG. 1;

FIG. 3 demonstrates schematically a transformation relationship between the robot-arm coordinate frame and the distance-sensor coordinate frame of FIG. 1;

FIG. 4A is a schematic front view of an operation of FIG. 1;

FIG. 4B is a schematic top view of FIG. 4A;

FIG. 5, FIG. 6, FIG. 6A and FIG. 6B illustrate schematically how the embodiment of FIG. 1 applies detection information of the distance sensor module to calculate a coordinate of a center;

FIG. 7 illustrates schematically how the embodiment of FIG. 1 calculates a real coordinate of the tool center point;

FIG. 8 illustrates schematically how the embodiment of FIG. 1 applies a circle equation and the least-squared error method to fit a radius with the least error so as further to derive a center coordinate and a circular radius; and

FIG. 9 is a schematic flowchart of an embodiment of the automated calibration method for a relation between a robot-arm coordinate frame and a profile-scanner coordinate frame in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

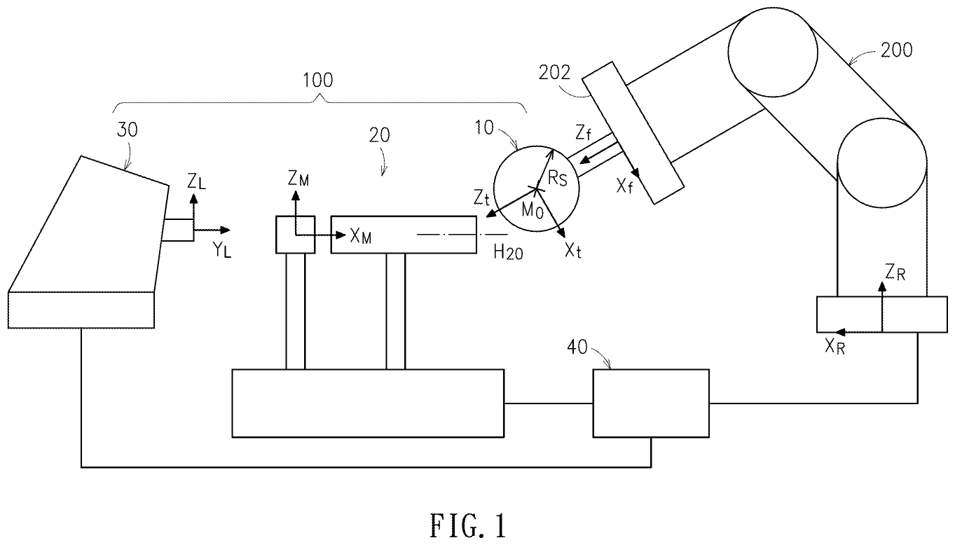

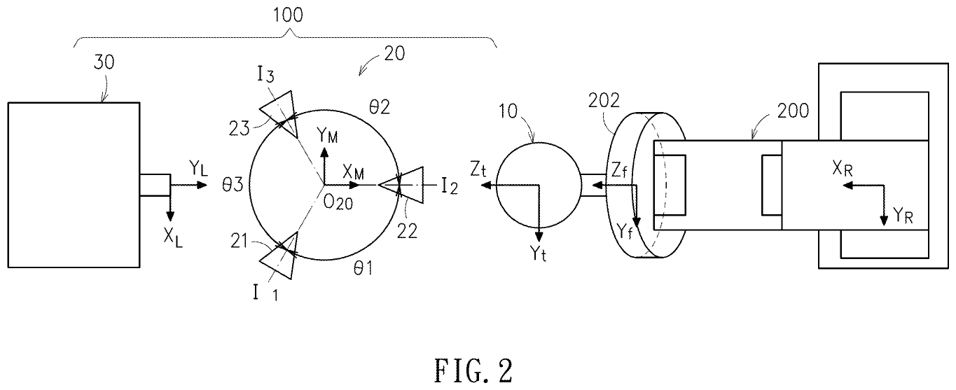

Referring now to FIG. 1 and FIG. 2, an automated calibration system for a relation between a robot-arm coordinate frame and a profile-scanner coordinate frame 100 provided in this disclosure includes a ball probe 10, a distance sensor module 20, a profile scanner 30 and a control module 40.

The ball probe 10 is attached on a flange 202 of a robot arm 200, and can be made of, but not limited to, a stainless steel or any metallic material with the like rigidity.

The distance sensor module 20 includes three distance sensors 21˜23.

The profile scanner 30, configured to detect a 2D cross-sectional profile of the ball probe 10, can be a 2D profile scanner or a 3D profile scanner.

FIG. 1 illustrates schematically connections among the robot arm 200, the distance sensor module 20, the profile scanner 30 and the control module 40. The control module 40, omitted in FIG. 2, is configured to control motions of the robot arm 20, the distance sensor module 20 and the profile scanner 30, and to carry out calculations and analysis during a calibration process. Generally, the control module 40 is, but not limited to, a computer.

In practical application, the robot arm 200 drives the tooling mounted on the flange 202 to complete preset tasks. In this disclosure, the distance sensor module 20 and the ball probe 10 having a predetermined radius and mounted on the flange 202 of the robot arm 200 are utilized to perform calibration of the positioning relationship between the robot arm 200 and the profile scanner 30.

Referring also to FIG. 1 and FIG. 2, according to this disclosure, the calibration of the tool center point (TCP) requires detected distance information of the distance sensors 21˜23, Pythagorean theorem and the circle equations. With the calibrated TCP, a circle fitting equation is applied to derive a relation between coordinate frames of the profile scanner 30 and the robot arm 200.

In the calibration, the ball probe 10 has a radius Rₛ, the robot arm 200 has a robot-arm coordinate frame X_{R}-Y_{R}-Z_{R}, the flange 202 has a flange coordinate frame X_{f}-Y_{f}-Z_{f}, the profile scanner 30 has a profile-scanner coordinate frame X_{L}-Y_{L}-Z_{L}, the ball probe 10 has a ball-probe coordinate frame Xₜ-Yₜ-Zₜ, and the distance sensor module 20 has a distance-sensor-module coordinate frame X_{M}-Y_{M}-Z_{M}.

The three distance sensors 21˜23 has three axes I₁, I₂, I₃, respectively, in which I₁, I₂ and I₃ shall share a common sensing plane H20, and intersect at a common point of intersection O₂₀. In addition, the angular relationship among these three axes I₁, I₂, I₃ is given. Angles θ₁, θ₂, θ₃ for the three axes I₁, I₂, I₃ can be arranged in a 120-degree equiangular distribution, or in an unequal angular distribution. The point of intersection O₂₀ is the origin of the distance-sensor-module coordinate frame X_{M}-Y_{M}-Z_{M}, as shown in FIG. 2.

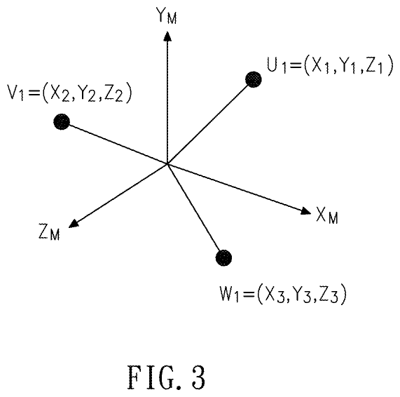

Referring now to FIG. 3 through FIG. 6, by having a spherical center Mₒ of the ball probe 10 having a predetermined radius Rₛ at the robot arm 200 to slide along the robot-arm coordinate frame X_{R}-Y_{R}-Z_{R}, then a transformation relationship between the robot-arm coordinate frame X_{R}-Y_{R}-Z_{R} and the distance-sensor-module coordinate frame X_{M}-Y_{M}-Z_{M} , can be derived, as shown in FIG. 3. The corresponding method thereto can include Steps (a1)˜(f1) as follows.

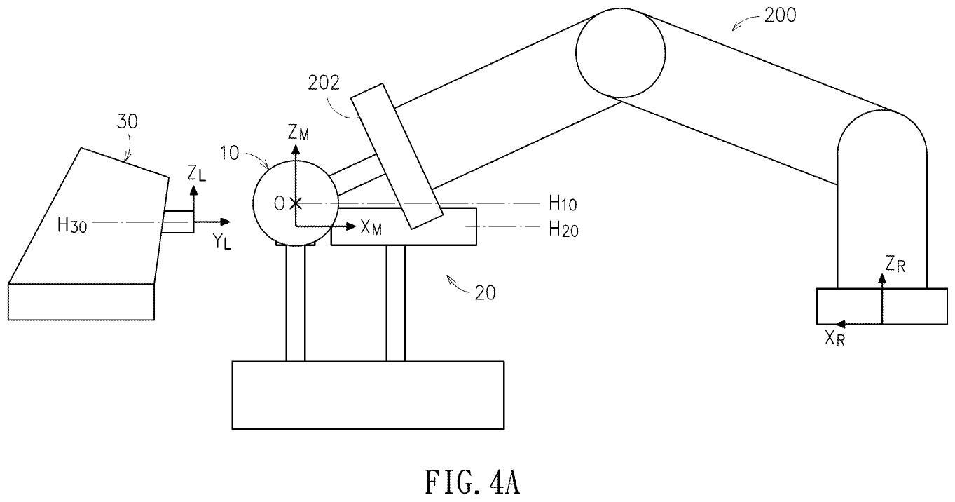

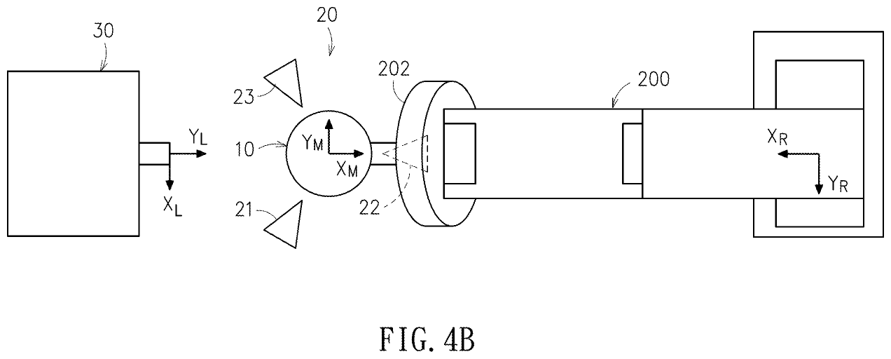

Step (a1): Control the robot arm 200 to move so as to have the ball probe 10 mounted on the flange 202 of the robot arm 200 to move along the three axial directions of the robot-arm coordinate frame X_{R}-Y_{R}-Z_{R} into the distance sensor module 20, such that the three distance sensors 21˜23 can generate simultaneously corresponding distance information of the ball probe 10. In particular, the sensing plane H₂₀ containing a movement onset position with respect to the distance sensor module 20 and a cross-sectional position H₁₀ containing the largest radius Rₛ of the ball probe 10 are not coplanar. As shown in FIG. 4A and FIG. 4B, the coordinate of the initial point O with respect to the distance-sensor-module coordinate frame X_{M}-Y_{M}-Z_{M} is then recorded. It is noted that the control module 40 is omitted in FIG. 4A and FIG. 4B.

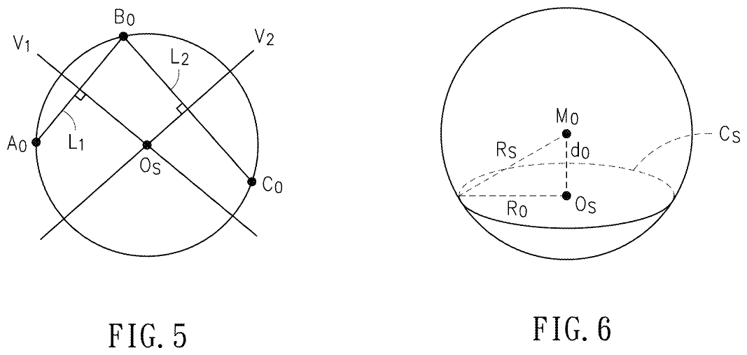

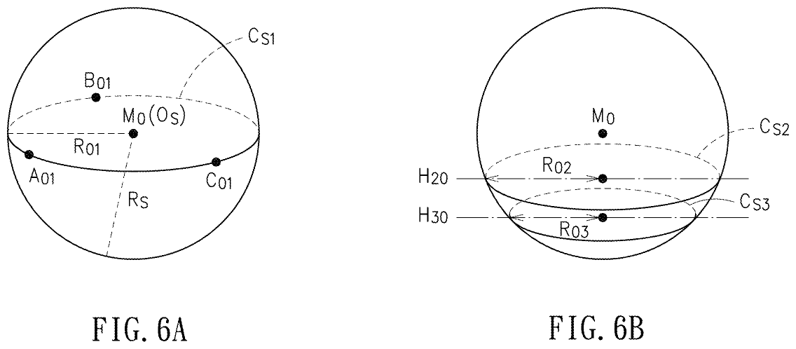

Step (b1): Utilize the detected distance information of the distance sensors 21˜23 to derive three coordinates A₀, B₀, C₀ of the ball probe 10 on the sensing plane H₂₀ with respect to the distance-sensor-module coordinate frame X_{M}-Y_{M}-Z_{M}, and thereby to calculate an initial point Oₛ on the cross-sectional circle containing the three coordinates A₀, B₀, C₀, as shown in FIG. 5 an FIG. 6. The corresponding computation method can include Steps (a11)˜(d11) as follows.

Step (a11): Utilize the three distance sensors 21˜23 to obtain

$${A}_{0} = [ \begin{matrix}{I}_{1} cos {t}_{1} \\ {I}_{1} sin {t}_{1} \\ 0\end{matrix} ] , {B}_{0} = [ \begin{matrix}{I}_{2} cos {t}_{2} \\ {I}_{2} sin {t}_{2} \\ 0\end{matrix} ] , {C}_{0} = [ \begin{matrix}{I}_{3} cos {t}_{3} \\ {I}_{3} sin {t}_{3} \\ 0\end{matrix} ] ,$$

in which lᵢ is the distance of point of intersection between one of the three axes I₁, I₂, I₃ and the ball probe 10 with respect to the distance-sensor-module coordinate frame Z_{M}, and tᵢ is the angle of each of the three axes I₁, I₂, I₃ with respect to the distance-sensor-module coordinate frame X_{M}.

Step (b11): Calculate two perpendicular bisectors V₁, V₂ to the line L₁ and the another line L₂, respectively, and calculate the two perpendicular bisectors V₁, V₂ to derive a coordinate F₀ of the center Oₛ of the cross-sectional circle with respect to the distance-sensor-module coordinate frame X_{M}-Y_{M}-Z_{M}.

Step (c11): Derive a radius R₀ of the cross-sectional circle C_{S} from the coordinate F₀ of the center Oₛ.

Step (d11): According to the Pythagorean theorem, calculate a height d₀=±\sqrt{Rₛ²−Rₒ²} of the spherical center M₀ of the ball probe 10 with respect to the cross-sectional circle C_{S}. Referring to FIG. 6, if the spherical center M₀ is located under the cross-sectional circle C_{S}, then d₀<0. Otherwise, d₀>0.

The spherical center M₀ can be determined from an initial state. If the initial state spherical center M₀ is located under the cross-sectional circle C_{S}, and the radius R₀ of the cross-sectional circle C_{S} keeps increasing or decreasing during the movement, then the spherical center M₀ would be maintained to be located under the cross-sectional circle C_{S}. However, during the movement, if the radius R₀ of the cross-sectional circle C_{S} decreases after an increase, then it implies that the spherical center M₀ is moved to be located above the cross-sectional circle C_{S}.

After the Step (b1) is performed, then keep performing Step (c1)˜(f1). Step (c1): Move the robot arm 200, from the initial point O, along an axial direction X_{R} of the robot-arm coordinate frame by an arbitrary length. Then, according to the aforesaid Steps (a11)˜(d11), calculate orderly a coordinate Fₓ, a radius Rₓ, a height dₓ, and a vector

$$U 1 = [ \begin{matrix} \\ {F}_{x} - {F}_{0} \\ \\ {d}_{x} - {d}_{0}\end{matrix} ]$$

of the robot-arm coordinate frame X_{R} with respect to the distance-sensor-module coordinate frame X_{M}-Y_{M}-Z_{M}.

Step (d1): Move the robot arm 200, from the initial point O, along another axial direction Y_{R} of the robot-arm coordinate frame by an arbitrary length. Then, according to the aforesaid Steps (a)˜(d), calculate orderly a coordinate F_{y}, a radius R_{y}, a height d_{y}, and a vector

$${V}_{1} = [ \begin{matrix} \\ {F}_{y} - {F}_{0} \\ \\ {d}_{y} - {d}_{0}\end{matrix} ]$$

of the robot-arm coordinate frame Y_{R} with respect to the distance-sensor-module coordinate frame X_{M}-Y_{M}-Z_{M}.

Step (e1): Move the robot arm 200, from the initial point O, along a third axial direction Z_{R} of the robot-arm coordinate frame by an arbitrary length. Then, according to the aforesaid Steps (a1)˜(d1), calculate orderly a coordinate F_{z}, a radius R_{z}, a height d_{z}, and a vector

$${W}_{1} = [ \begin{matrix} \\ {F}_{z} - {F}_{0} \\ \\ {d}_{z} - {d}_{0}\end{matrix} ]$$

of the robot-arm coordinate frame Z_{R} with respect to the distance-sensor-module coordinate frame X_{M}-Y_{M}-Z_{M}.

Step (f1): Obtain the transformation relationship

$${S}_{R} = {[ \begin{matrix}\begin{matrix}\frac{{U}_{1}}{‖ {U}_{1} ‖} & \frac{{V}_{1}}{‖ {V}_{1} ‖}\end{matrix} & \frac{{W}_{1}}{‖ {W}_{1} ‖}\end{matrix} ]}^{- 1} {S}_{M}$$

between the robot-arm coordinate frame X_{R}-Y_{R}-Z_{R} and the distance-sensor-module coordinate frame X_{M}-Y_{M}-Z_{M}, in which S_{R} is the movement along the robot-arm coordinate frame X_{R}-Y_{R}-Z_{R}, S_{M} is the movement along the distance-sensor-module coordinate frame X_{M}-Y_{M}-Z_{M}.

Referring now to FIG. 1, FIG. 2 and FIG. 6A, after the transformation relationship between the robot-arm coordinate frame X_{R}-Y_{R}-Z_{R} and the distance-sensor-module coordinate frame X_{M}-Y_{M}-Z_{M} is obtained, then control the spherical center M₀ of the ball probe 10 at a different posture to coincide with the origin O₂₀ of the distance-sensor-module coordinate frame X_{M}-Y_{M}-Z_{M}, so that the TCP calibration point information can be calculated (i.e., the position information of the spherical center M₀ of the ball probe 10 with the known radius R_{S} on the robot arm 200 with respect to the flange coordinate frame X_{f}-Y_{f}-Z_{f}). The method can include Steps (a2)˜(d2) as follows.

Step (a2): Utilize the distance information detected by the distance sensor module 20 to obtain at least three circular coordinates A₀, B₀, C₀ on the cross-sectional circle and further to calculate a coordinate C′ of a center of the cross-sectional circle C_{S1}, and then utilize

$${S}_{R} = - {[ \begin{matrix}\begin{matrix}\frac{{U}_{1}}{‖ {U}_{1} ‖} & \frac{{V}_{1}}{‖ {V}_{1} ‖}\end{matrix} & \frac{{W}_{1}}{‖ {W}_{1} ‖}\end{matrix} ]}^{- 1} {C}^{′}$$

to control the center Oₛ of the cross-sectional circle Cₛ to coincide with a Z-axial direction Z_{M} of the distance-sensor-module coordinate frame.

Step (b2): Control the robot arm 200 to move along the direction

$${S}_{R} = - {[ \begin{matrix}\begin{matrix}\frac{{U}_{1}}{‖ {U}_{1} ‖} & \frac{{V}_{1}}{‖ {V}_{1} ‖}\end{matrix} & \frac{{W}_{1}}{‖ {W}_{1} ‖}\end{matrix} ]}^{- 1} {Z}_{M} ,$$

and utilize the distance sensor module 20 to capture in a real-time manner three circular coordinates A₀₁, B₀₁, C₀₁ on the cross-sectional circle C_{S1} for calculating a radius R₀₁ of the cross-sectional circle C_{S1}. If R₀₁=R_{S} of the ball probe 10, it implies that the sensing plane H₂₀ is coincided with the spherical center M₀. Thus, record this point into the calibration point information of the TCP. If a number of the recorded calibration points in the calibration point information of the TCP is greater than 4, then the obtaining of the calibration points is complete. On the other hand, if the number of the recorded calibration points in the calibration point information of the TCP is less than 4, then go to perform Step (c2).

Step (c2): Utilize a random number generator to generate a Euler angle increment ΔRₓ, ΔR_{y}, ΔR_{z}.

Step (d2): Having the Euler angles of the robot arm 200 to be Rₓ=Rₓ+ΔRₓ, R_{y}=R_{y}+ΔR_{y}, R_{z}=R_{z}+ΔR_{z}, then move the robot arm 200 to this new azimuth. If this set of Euler angles exceeds a movement limit, then go back to the Steps (c2) and (d2) for generating another set of Euler angles. Otherwise, go back to the Step (a2) for generating another calibration point information.

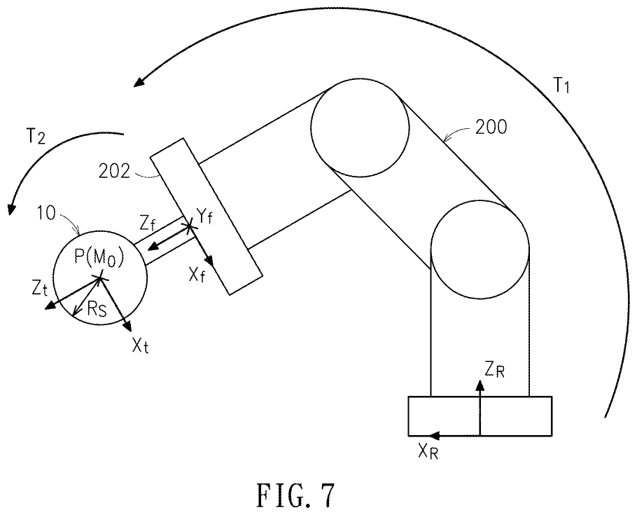

Referring now to FIG. 1, FIG. 2 and FIG. 7, after sufficient calibration point information of the TCP has been gathered, then go to perform the TCP calibration to calculate the position of the spherical center M₀ of the ball probe 10 having the known radius R_{S} on the robot arm 200 with respect to the flange coordinate frame X_{f}-Y_{f}-Z_{f}; i.e., the coordinate of the TCP. A spatial coordinate of the calibration point P (equivalent to the spherical center M₀ of the ball probe 10) can be obtained by the information of link parameters, joint coordinates and the TCP of the robot arm 200 with respect to the flange coordinate frame X_{f}-Y_{f}-Z_{f}:

T₁ᵢT₂=P

in which

$${T}_{1 i} = [ \begin{matrix} & & & \\ & {R}_{1 i} & & {L}_{1 i} \\ & & & \\ 0 & 0 & 0 & 1\end{matrix} ]$$

is the 4×4 homogeneous transformation matrix for the i-th calibration point to transform coordinates from the flange coordinate frame X_{f}-Y_{f}-Z_{f} to the robot-arm coordinate frame X_{R}-Y_{R}-Z_{R}, R₁ᵢ is a 3×3 sub-transformation matrix at the upper left corner of the homogeneous transformation matrix, and L₁ᵢ is a vector formed by the top three entries of the fourth column of the homogeneous transformation matrix. By plugging the link parameters and the joint coordinates, this 4×4 homogeneous transformation matrix would become a constant matrix.

T₂=[Tₓ T_{y} T_{z} 1]^{T} is the coordinate of the TCP with respect to the coordinate of the flange 202 coordinate, and P=[Pₓ P_{y} P_{z} 1]^{T} is the spatial coordinate of the calibration point with respect to the robot-arm coordinate frame X_{R}-Y_{R}-Z_{R}. After four calibration points have been collected, then:

$${T}_{2} = {[ \begin{matrix} & {R}_{11} & & {L}_{11} \\ & {R}_{12} & & {L}_{12} \\ & {R}_{13} & & {L}_{13} \\ & {R}_{14} & & {L}_{14}\end{matrix} ]}^{T} {( {[ \begin{matrix} & {R}_{11} & & {L}_{11} \\ & {R}_{12} & & {L}_{12} \\ & {R}_{13} & & {L}_{13} \\ & {R}_{14} & & {L}_{14}\end{matrix} ] [ \begin{matrix} & {R}_{11} & & {L}_{11} \\ & {R}_{12} & & {L}_{12} \\ & {R}_{13} & & {L}_{13} \\ & {R}_{14} & & {L}_{14}\end{matrix} ]}^{T} )}^{- 1} [ \begin{matrix}{P}_{x} \\ {P}_{y} \\ {P}_{z} \\ 1\end{matrix} ]$$

can be used to calculate the coordinate of the TCP, and so the TCP calibration is complete.

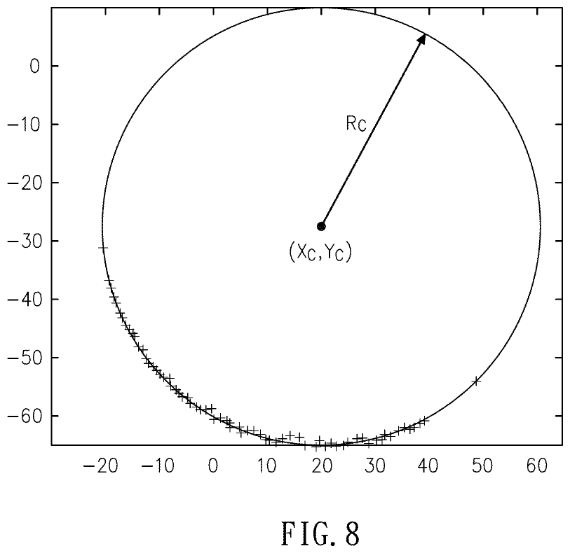

Referring now to FIG. 1, FIG. 2, FIG. 4A, FIG. 4B, FIG. 6 and FIG. 8, after the TCP coordinate is obtained, then the ball probe 10 having a predetermined radius R_{S} on the robot arm 200 would be moved to a position demonstrating a profile able to be captured with respect to the profile-scanner coordinate frame X_{L}-Y_{L}-Z_{L}, and simultaneously to obtain a coordinate Bⱼ of the spherical center M₀ of the ball probe 10 having the known radius R_{S} with respect to the robot-arm coordinate frame X_{R}-Y_{R}-Z_{R} and another coordinate Wⱼ thereof with respect to the profile-scanner coordinate frame X_{L}-Y_{L}-Z_{L}. The method thereto includes Steps (a3)˜(e3) as follows.

Step (a3): Define j=1, and move the robot arm 200 to dispose the ball probe 10 mounted on the flange 202 of the robot arm 200 into the distance sensor module 20, such that all the three distance sensors 21˜23 and the profile scanner 30 can read simultaneously information related to the ball probe 10. According to this disclosure, the sensing plane H₂₀ formed by the distance sensor module 20 and the cross-sectional plane H₁₀ of the ball probe 10 containing the largest radius Rₛ thereof can be either coplanar or non-coplanar.

Step (b3): Record the coordinate Bⱼ of the spherical center M₀ of the ball probe 10 having the known radius R_{S} with respect to the robot-arm coordinate frame X_{R}-Y_{R}-Z_{R}, in which Bⱼ=T₁ⱼT₂ and

$${T}_{1 j} = [ \begin{matrix} & & & \\ & {R}_{1 j} & & {L}_{1 j} \\ & & & \\ 0 & 0 & 0 & 1\end{matrix} ] .$$

T₁ⱼ is the 4×4 homogeneous transformation matrix to transform coordinates from the flange coordinate frame X_{f}-Y_{f}-Z_{f} to the robot-arm coordinate frame X_{R}-Y_{R}-Z_{R}.

Step (c3): Utilize the profile scanner 30 to capture the cross-sectional profile information of the ball probe 10, and obtain profile-point set information xᵢ, yᵢ with respect to the profile-scanner coordinate frame X_{L}-Y_{L}-Z_{L}. By introducing the circle equation (x−x_{c})²+(y−y_{c})²=R_{c}² and the least-squared error method to perform fitting for minimizing the error upon the radius, then the center coordinate (x_{cj}, y_{cj}) and the sectional-circle radius R_{cj} of the cross-sectional circle can be calculated, as shown in FIG. 8.

$$[ \begin{matrix}{x}_{cj} \\ {y}_{cj} \\ {R}_{cj}\end{matrix} ] = {[ \begin{matrix}{x}_{1} & {y}_{1} & 1 \\ {x}_{2} & {y}_{2} & 1 \\ ⋮ & ⋮ & ⋮ \\ {x}_{i} & {y}_{i} & 1\end{matrix} ]}^{†} [ \begin{matrix}- ( {x}_{1}^{2} + {y}_{1}^{2} ) \\ - ( {x}_{2}^{2} + {y}_{2}^{2} ) \\ \\ - ( {x}_{i}^{2} + {y}_{i}^{2} )\end{matrix} ]$$

in which

$${[ \begin{matrix}{x}_{1} & {y}_{1} & 1 \\ {x}_{2} & {y}_{2} & 1 \\ ⋮ & ⋮ & ⋮ \\ {x}_{i} & {y}_{i} & 1\end{matrix} ]}^{†} = {{( {[ \begin{matrix}{x}_{1} & {y}_{1} & 1 \\ {x}_{2} & {y}_{2} & 1 \\ ⋮ & ⋮ & ⋮ \\ {x}_{i} & {y}_{i} & 1\end{matrix} ]}^{T} [ \begin{matrix}{x}_{1} & {y}_{1} & 1 \\ {x}_{2} & {y}_{2} & 1 \\ ⋮ & ⋮ & ⋮ \\ {x}_{i} & {y}_{i} & 1\end{matrix} ] )}^{- 1} [ \begin{matrix}{x}_{1} & {y}_{1} & 1 \\ {x}_{2} & {y}_{2} & 1 \\ ⋮ & ⋮ & ⋮ \\ {x}_{i} & {y}_{i} & 1\end{matrix} ]}^{T}$$

is a pseudo-inverse matrix.

Step (d3): Utilize the Pythagorean theorem to calculate a distance Z_{cj}=±\sqrt{Rₛ₂²−R_{cj}²} between the spherical center M₀ and the cross-sectional circle C_{S2}. If the radius R₀₂ of the cross-sectional circle C_{S2} captured by the distance sensors 21˜23 is larger than the radius R₀₃ of the cross-sectional circle C_{S3} captured by the profile scanner 30 (i.e., the sensing plane H₂₀ of the distance sensors 21˜23 is located above the sensing plane H₃₀ of the profile scanner 30, as shown in FIG. 6B), then it implies that the spherical center M₀ is located above the cross-sectional circle C_{S3} of the profile scanner 30, and thus Z_{cj}>0. On the other hand, if the radius R₀₂ of the cross-sectional circle C_{S2} captured by the distance sensors 21˜23 is smaller than the radius R₀₃ of the cross-sectional circle C_{S3} captured by the profile scanner 30 (i.e., the sensing plane H₂₀ of the distance sensors 21˜23 is located under the sensing plane H₃₀ of the profile scanner 30), then it implies that the spherical center M₀ is located under the cross-sectional circle C_{S3} of the profile scanner 30, and thus Z_{cj}<0.

Step (e3): Record

$${W}_{j} = [ \begin{matrix}{x}_{cj} \\ {y}_{cj} \\ {z}_{cj}\end{matrix} ]$$

as the coordinate of the spherical center M₀ of the ball probe 10 with respect to the profile-scanner coordinate frame X_{L}-Y_{L}-Z_{L}, and then define j=j+1. If j>4, then the capturing of the calibration point information is complete. Otherwise, apply a random number generator to generate a movement increment, and then vary the position of the robot arm according to Pₓ=Rₓ+ΔPₓ, P_{y}=P_{y}+ΔP_{y}, P_{z}=P_{z}+ΔP_{z}, Rₓ=Rₓ+ΔRₓ, R_{y}=R_{y}+ΔR_{y}, R_{z}=R_{z}+ΔR_{z}. If this position exceeds a preset movement limit or detection range, then regenerate the movement increment. Thereafter, go to Step (b3) for generating information of the next calibration point to amend the calibration point information.

After coordinates of all four arbitrary calibration points with respect to the profile-scanner coordinate frame X_{L}-Y_{L}-Z_{L} are obtained, the further calculation can be proceeded. In the following description, upon after all the coordinates of at least four calibration points with respect to the profile-scanner coordinate frame X_{L}-Y_{L}-Z_{L} and the robot-arm coordinate frame X_{R}-Y_{R}-Z_{R} are obtained, then the relationship among these coordinates can be utilized to further calculate the transformation relationship between the robot-arm coordinate frame X_{R}-Y_{R}-Z_{R} and the profile-scanner coordinate frame X_{L}-Y_{L}-Z_{L}.

The transformation matrix for the profile-scanner coordinate frame X_{L}-Y_{L}-Z_{L} with respect to the robot-arm coordinate frame X_{R}-Y_{R}-Z_{R} can be formed as:

$${T}_{3} = {[ \begin{matrix} & & & \\ {B}_{1} & {B}_{2} & {B}_{3} & {B}_{4} \\ & & & \\ 0 & 0 & 0 & 1\end{matrix} ] [ \begin{matrix} & & & \\ {W}_{1} & {W}_{2} & {W}_{3} & {W}_{4} \\ & & & \\ 0 & 0 & 0 & 1\end{matrix} ]}^{- 1} ,$$

in which Bⱼ and Wⱼ are the coordinates of the j-th calibration point with respect to the robot-arm coordinate frame X_{R}-Y_{R}-Z_{R} and the profile-scanner coordinate frame X_{L}-Y_{L}-Z_{L}, respectively.

Then, input all the calculated coordinates into the control module 40, and thus the calibration process can be complete.

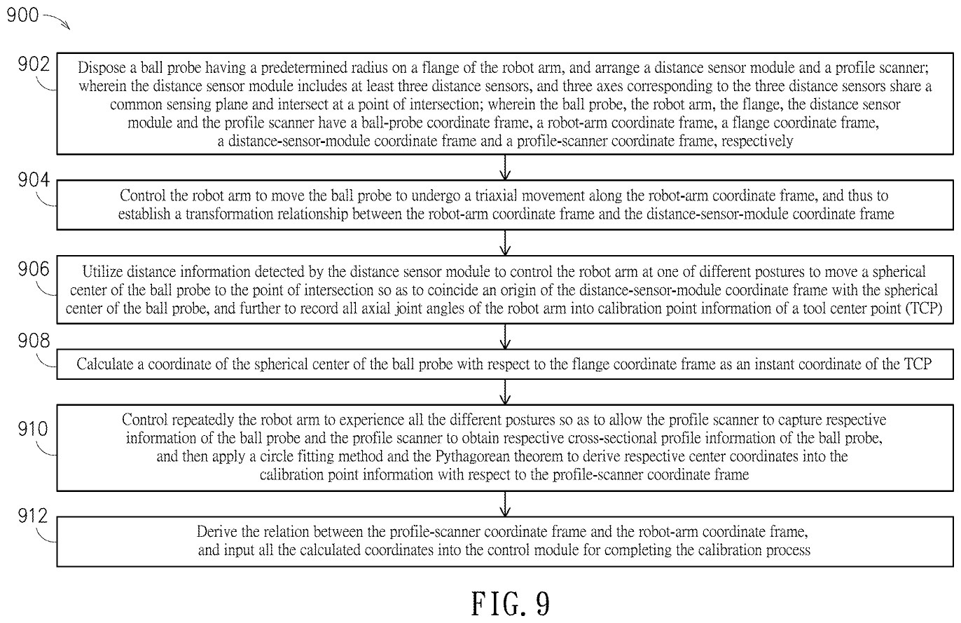

Referring now to FIG. 9, as described above, the calibration method 900 for a relation between a robot-arm coordinate frame and a profile-scanner coordinate frame in accordance with this disclosure can include the steps as follows.

Step 902: Dispose a ball probe having a predetermined radius on a flange of the robot arm, and arrange a distance sensor module and a profile scanner; wherein the distance sensor module includes at least three distance sensors, and three axes corresponding to the three distance sensors share a common sensing plane and intersect at a point of intersection; wherein the ball probe, the robot arm, the flange, the distance sensor module and the profile scanner have a ball-probe coordinate frame, a robot-arm coordinate frame, a flange coordinate frame, a distance-sensor-module coordinate frame and a profile-scanner coordinate frame, respectively.

Step 904: Control the robot arm to move the ball probe to undergo a triaxial movement along the robot-arm coordinate frame, and thus to establish a transformation relationship between the robot-arm coordinate frame and the distance-sensor-module coordinate frame.

Step 906: Utilize distance information detected by the distance sensor module to control the robot arm at one of different postures to move a spherical center of the ball probe to the point of intersection so as to coincide an origin of the distance-sensor-module coordinate frame with the spherical center of the ball probe, and further to record all axial joint angles of the robot arm into calibration point information of a tool center point (TCP).

Step 908: Calculate a coordinate of the spherical center of the ball probe with respect to the flange coordinate frame as an instant coordinate of the TCP.

Step 910: Control repeatedly the robot arm to experience all the different postures so as to allow the profile scanner to capture respective information of the ball probe and the profile scanner to obtain respective cross-sectional profile information of the ball probe, and then apply a circle fitting method and the Pythagorean theorem to derive respective center coordinates into the calibration point information with respect to the profile-scanner coordinate frame.

Step 912: Derive the relation between the profile-scanner coordinate frame and the robot-arm coordinate frame, and input all the calculated coordinates into the control module for completing the calibration process.

In summary, in the automated calibration method and system for a relation between a robot-arm coordinate frame and a profile-scanner coordinate frame provided by this disclosure, after the ball probe having a predetermined radius is mounted onto the robot arm, a plurality of coplanar distance sensors are introduced to obtain a relationship between the ball probe and the flange of the robot arm by utilizing a circle fitting equation and the Pythagorean theorem, and the profile scanner is further introduced to obtain the ball-probe profile information at a plurality of different postures, such that the relation between the profile-scanner coordinate frame and the robot-arm coordinate frame can be calculated for performing the calibration process.

According to this disclosure, no physical feature point is needed in the coordinate frame, no fixture is required to perform as a calibration medium, no CAD model should be applied as an assistance, and no additional 3D measurement device is required for calibrating the spatial position of the device. With this method and system of this disclosure, calibration of the coordinate frames can be completed in one operation procedure with enhanced calibration precision, and the aforesaid shortcomings in the art that the coordinate frame should have physical feature points and a fixture should be applied to improve the accuracy of calibration can be substantially resolved.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An automated calibration method for a relation between a robot-arm coordinate frame and a profile-scanner coordinate frame, comprising the steps of:
(a) disposing a ball probe having a predetermined radius on a flange of a robot arm, and arranging a distance sensor module and a profile scanner, the distance sensor module including at least three distance sensors, three axes corresponding to the three distance sensors sharing a common sensing plane and intersecting at a point of intersection; wherein the ball probe, the robot arm, the flange, the distance sensor module and the profile scanner have a ball-probe coordinate frame, a robot-arm coordinate frame, a flange coordinate frame, a distance-sensor-module coordinate frame and a profile-scanner coordinate frame, respectively;
(b) controlling the robot arm to move the ball probe to undergo a triaxial movement along the robot-arm coordinate frame, and thus to establish a transformation relationship between the robot-arm coordinate frame and the distance-sensor-module coordinate frame;
(c) utilizing distance information detected by the distance sensor module to control the robot arm at one of different postures to move a spherical center of the ball probe to the point of intersection, so as to coincide an origin of the distance-sensor-module coordinate frame with the spherical center of the ball probe, and further to record all axial joint angles of the robot arm into calibration point information of a tool center point (TCP);
(d) calculating a coordinate of the spherical center of the ball probe with respect to the flange coordinate frame as an instant coordinate of the TCP;
(e) controlling repeatedly the robot arm to experience all the different postures so as to allow the profile scanner to capture respective information of the ball probe and the profile scanner to obtain respective cross-sectional profile information of the ball probe, and to apply a circle fitting method and the Pythagorean theorem to derive respective center coordinates into the calibration point information with respect to the profile-scanner coordinate frame; and
(f) deriving the relation between the profile-scanner coordinate frame and the robot-arm coordinate frame, and inputting all the calculated coordinates into a control module for completing calibration.

2. The automated calibration method for the relation between the robot-arm coordinate frame and the profile-scanner coordinate frame of claim 1, wherein the Step (b) further includes the steps of:
(a1) controlling the robot arm to move the ball probe to undergo the triaxial movement along the robot-arm coordinate frame, so as to have the three distance sensors simultaneously to read corresponding distance information of the ball probe; wherein a sensing plane formed by the distance sensor module at a movement onset position is not coplanar with a cross-sectional circle containing the largest radius of the ball probe, and corresponding coordinates with respect to the distance-sensor-module coordinate frame are recorded;
(b1) utilizing the distance information detected by the three distance sensors to calculate coordinates of at least three points of the ball probe on the sensing plane with respect to the distance-sensor-module coordinate frame, and further to calculate a center of the cross-sectional circle as an initial point;
(c1) moving the robot arm, from the initial point, along three axial directions (X, Y, Z) of the robot-arm coordinate frame by an arbitrary length, so as to calculate a vector corresponding to the three axial directions of the robot-arm coordinate frame with respect to the distance-sensor-module coordinate frame; and
(d1) utilizing the vector derived in the Step (c1) to calculate the transformation relationship between the robot-arm coordinate frame and the distance-sensor-module coordinate frame.

3. The automated calibration method for the relation between the robot-arm coordinate frame and the profile-scanner coordinate frame of claim 2, wherein the Step (b1) further includes the steps of:
(a11) utilizing the three distance sensors to calculate three circular coordinates A₀, B₀, C₀;
(b11) connecting the circular coordinate A₀ and the circular coordinate B₀ to form a line and the circular coordinate B₀ and the circular coordinate C₀ to form another line, calculating two perpendicular bisectors respective to the line and the another line, and calculating the two perpendicular bisectors to derive a coordinate of the center of the cross-sectional circle with respect to the distance-sensor-module coordinate frame;
(c11) deriving a radius of the cross-sectional circle from the coordinate of the center obtained in the Step (b11); and
(d11) according to the Pythagorean theorem, calculating a height of the spherical center of the ball probe with respect to the cross-sectional circle.

4. The automated calibration method for the relation between the robot-arm coordinate frame and the profile-scanner coordinate frame of claim 3, wherein, in the Step (d11), the height <0 if the spherical center is located under the cross-sectional circle, and the height >0 if the spherical center is located above the cross-sectional circle.

5. The automated calibration method for the relation between the robot-arm coordinate frame and the profile-scanner coordinate frame of claim 1, wherein the Step (c) further includes the steps of:
(a2) utilizing the distance information detected by the distance sensor module to obtain at least three circular coordinates on the cross-sectional circle and further to calculate a coordinate of a center of the cross-sectional circle, so as to control the center of the cross-sectional circle to coincide with a Z-axial direction of the distance-sensor-module coordinate frame;
(b2) according to the transformation relationship between the robot-arm coordinate frame and the distance-sensor-module coordinate frame, controlling the robot arm to move, and having the distance sensor module to capture the at least three circular coordinates on the cross-sectional circle and to calculate a radius of the cross-sectional circle; if the radius of the cross-sectional circle is equal to the radius of the ball probe, implying that the sensing plane is coincided with the spherical center of the ball probe, and recording the coordinate of the center into the calibration point information of the TCP; if a number of calibration points in the calibration point information is at least greater than 4, then finishing to obtain the calibration points; if the number of calibration points in the calibration point information is at least less than 4, then going to perform Step (c2);
(c2) utilizing a random number generator to generate Euler angle increments; and
(d2) utilizing the Euler angle increments to calculate Euler angles of the robot arm, and then moving the robot arm to a position corresponding to the Euler angles; if the position exceeds a movement limit, then going back to the Steps (c2) and (d2) for generating another Euler angle increments; otherwise, going back to the Step (a2) for generating another calibration point information.

6. The automated calibration method for the relation between the robot-arm coordinate frame and the profile-scanner coordinate frame of claim 1, wherein the Step (d) utilizes information of the robot arm in link parameters, joint coordinates and the TCP with respect to the flange coordinate frame to obtain spatial coordinates of at least four calibration points, and thus the spherical center of the ball probe with respect to the flange coordinate frame is calculated to be the coordinate of the TCP.

7. The automated calibration method for the relation between the robot-arm coordinate frame and the profile-scanner coordinate frame of claim 1, wherein the Step (e) further includes the steps of:
(a3) controlling the robot arm to move the ball probe into the distance sensor module so as to have the three distance sensors and the profile scanner able to simultaneously read information with respect to the ball probe, the sensing plane formed by the distance sensor module and the cross-sectional circle of the ball probe having the largest radius being coplanar or non-coplanar;
(b3) recording a coordinate of the spherical center of the ball probe with respect to the robot-arm coordinate frame;
(c3) utilizing the profile scanner to capture the cross-sectional profile information of the ball probe and to obtain profile-point set information with respect to the profile-scanner coordinate frame, and applying a circle equation and a least-squared error method to perform fitting so as to derive a coordinate of a center of a cross-sectional circle and a radius of the cross-sectional circle;
(d3) applying the Pythagorean theorem to calculate a distance between the spherical center and the cross-sectional circle; and
(e3) recording a coordinate of the spherical center of the ball probe with respect to the profile-scanner coordinate frame into the calibration point information.

8. The automated calibration method for the relation between the robot-arm coordinate frame and the profile-scanner coordinate frame of claim 7, wherein, in the Step (d3), the spherical center is located above the cross-sectional circle of the profile scanner if the radius of the cross-sectional circle obtained by the three distance sensors is larger than the radius of the cross-sectional circle of the profile scanner, and the spherical center is located under the cross-sectional circle of the profile scanner if the radius of the cross-sectional circle obtained by the three distance sensors is smaller than the radius of the cross-sectional circle of the profile scanner.

9. The automated calibration method for the relation between the robot-arm coordinate frame and the profile-scanner coordinate frame of claim 7, wherein, in the Step (e3), if the calibration point information includes at least four calibration points, then obtaining of the calibration point information is finished; otherwise, a random number generator is applied to generate a movement increment so as to move the robot arm accordingly to another position of the different postures; wherein, if the another position exceeds a movement limit or a detection range, another movement increment is generated; and, otherwise, go to the Step (b3) to form another calibration point information.

10. The automated calibration method for the relation between the robot-arm coordinate frame and the profile-scanner coordinate frame of claim 1, wherein, after at least four calibration point coordinates are obtained with respect to the profile-scanner coordinate frame and the robot-arm coordinate frame in the Step (f), a coordinate relation and a transformation matrix are utilized to calculate the transformation relationship between the robot-arm coordinate frame and the profile-scanner coordinate frame.

11. The automated calibration method for the relation between the robot-arm coordinate frame and the profile-scanner coordinate frame of claim 1, wherein the robot arm, the distance sensor module and the profile scanner are all electrically connected with the control module, such that the control module is able to control the robot arm, the distance sensor module and the profile scanner to move and perform calculations in the Step (b) through the Step (f).

12. An automated calibration system for a relation between a robot-arm coordinate frame and a profile-scanner coordinate frame, comprising:
a ball probe, attached on a flange of a robot arm;
a distance sensor module, including at least three distance sensors, three axes corresponding to the three distance sensors being coplanar with a sensing plane of the at least three distance sensors, the three axes being intersected at a point of intersection;
a profile scanner, used for detecting a 2D cross-sectional profile of the ball probe; and
a control module, electrically connected with the distance sensor module, the profile scanner and the robot arm, configured for controlling the robot arm to move the ball probe for obtaining calibration point information.
